(19) United States
(12) Patent Application Publication
(10) Pub. No.: US 2026/0319939 A1
(43) Pub. Date: Oct. 15, 2026

(54) DETECTING BUGS ASSOCIATED WITH PROGRAMS USING VISUALIZATIONS

(71) Applicant: International Business Machines Corporation, Armonk, NY (US)

(72) Inventors: Jing Yan Zhang, Beijing (CN); Mai Zeng, Beijing (CN); Xiao Chen Huang, Beijing (CN); Peng Hui Jiang, Beijing (CN); Wen Wen Guo, Beijing (CN)

(21) Appl. No.: 19/179,317

(22) Filed: Apr. 15, 2025

(51) Int. Cl. G06F 11/3698; G06F 11/3668

(52) U.S. Cl. CPC G06F 11/3698; G06F 11/3688; G06F 11/3692

(57) ABSTRACT

A computer-implemented method is provided. A processor set receives a number of software artifacts for a program. The number of software artifacts comprise at least one of source code or executable binaries for running the program. The processor set analyzes the number of software artifacts for the program to identify code execution flows for the program. The processor set generates a number of visualizations associated with the number of software artifacts based on the code execution flows for the program. The number of visualizations are interactive visualizations displayed in a graphical user interface for a user. The processor set identifies a number of bugs associated with the number of software artifacts for the program based on the number of visualizations associated with the number of software artifacts.

### BACKGROUND

The disclosure relates generally to detecting bugs associated with programs using visualizations.

Bug detection is the process of identifying errors, flaws, or unintended behavior in a software system that may affect its functionality, performance, or security. Bugs usually arise due to incorrect logic, improper handling of inputs, memory issues, or integration failure between different components. In this case, detecting and resolving bugs is a critical part of the software development lifecycle because it ensures reliability, enhances user experience, and prevents potential system failures.

Conventional methods of bug detection usually involve manual and automated approaches. Manual testing is performed by developers or testers who interact with the software to identify defects through functional testing, exploratory testing, or user simulations. Code reviews are another common practice where developers analyze each other's code to detect logical errors, inconsistencies, or deviations from coding standards. On the other hand, automated methods such as static code analysis involve scanning the source code for syntax errors, security vulnerabilities, or compliance issues without executing the program.

In an alternative approach, logging and real-time monitoring can also help detect bugs in production environment. Applications generate logs that record errors, warnings, and system events that can be analyzed to identify patterns and diagnose issues.

### SUMMARY

According to one illustrative embodiment, a computer-implemented method is provided. A processor set receives a number of software artifacts for a program. The number of software artifacts comprise at least one of source code or executable binaries for running the program. The processor set analyzes the number of software artifacts for the program to identify code execution flows for the program. The processor set generates a number of visualizations associated with the number of software artifacts based on the code execution flows for the program. The number of visualizations are interactive visualizations displayed in a graphical user interface for a user. The processor set identifies a number of bugs associated with the number of software artifacts for the program based on the number of visualizations associated with the number of software artifacts. According to other illustrative embodiments, a computer system and a computer program product are also provided.

### BRIEF DESCRIPTION OF THE DRAWINGS

FIG. 1 is a pictorial representation of a computing environment in which illustrative embodiments may be implemented;

FIG. 2 is an illustration of a block diagram of a program instruction management environment in accordance with an illustrative embodiment;

FIG. 3 is an illustration of visualizations generated for a program in accordance with an illustrative embodiment;

FIG. 4 is an illustration of visualizations generated for a program in accordance with an illustrative embodiment;

FIG. 5 is an illustration of annotated visualizations generated for a program in accordance with an illustrative embodiment;

FIG. 6 is a flowchart of a process for identifying bugs in accordance with an illustrative embodiment;

FIG. 7 is a flowchart of a process for generating visualizations for the program in accordance with an illustrative embodiment;

FIG. 8 is a flowchart of a process for recording data in accordance with an illustrative embodiment;

FIG. 9 is a flowchart of a process for displaying visualizations for the program in accordance with an illustrative embodiment;

FIG. 10 is a flowchart of a process for training a number of machine learning models in accordance with an illustrative embodiment; and

FIG. 11 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one or more storage media (also called "mediums") collectively included in a set of one or more storage devices that collectively include machine readable code corresponding to instructions and/or data for performing computer operations specified in a given CPP claim. A "storage device" is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

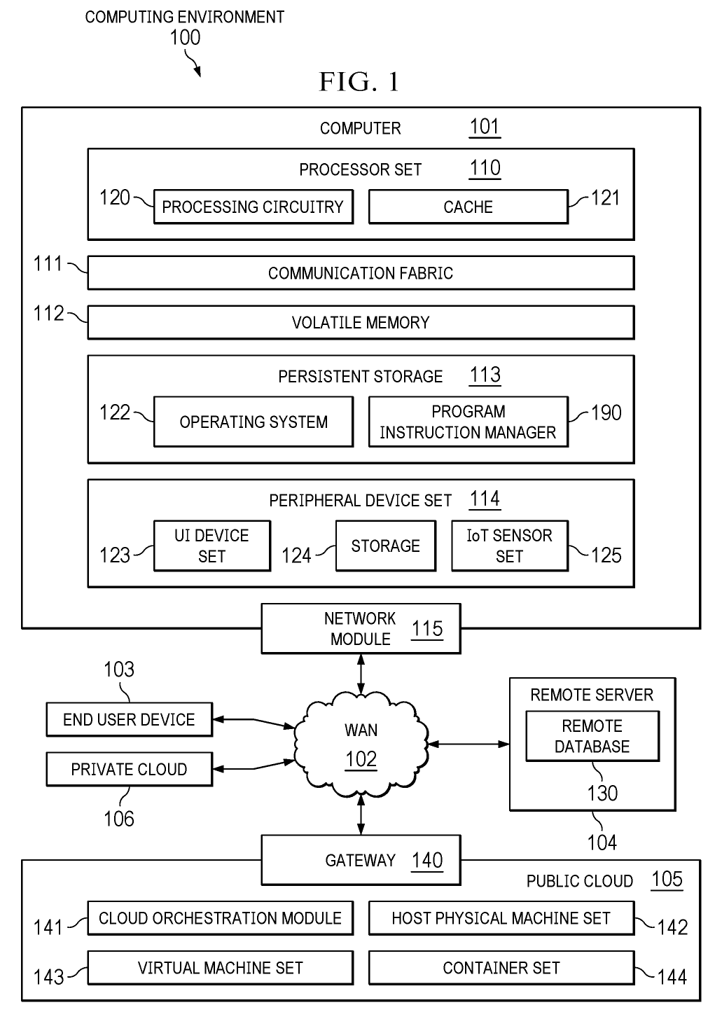

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as program instruction manager 190. In addition to program instruction manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and program instruction manager 190, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, or querying a database such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in program instruction manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in program instruction manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider’s systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that debugging tools can further be used to assist developers in bugs detection process by allowing developers to step through code execution, analyze variable states, and trace program flow to identify the root causes of bugs.

The illustrative embodiments also recognize and take into account that debugging and troubleshooting for programs can be hard because test environments and developing environments are usually separate. It is difficult for developers to reproduce issues occurring in the test environment in the developing environment.

The illustrative embodiments also recognize and take into account that there is no visualization method to conveniently determine the difference of variables and code execution. Usually, running a report of code execution only provides the input and output while leaving the whole testing process as a black box.

Thus, illustrative embodiments of the present invention provide a computer implemented method, computer system, and computer program product. A processor set receives a number of software artifacts for a program. The number of software artifacts comprise at least one of source code or executable binaries for running the program. The processor set analyzes the number of software artifacts for the program to identify code execution flows for the program. The processor set generates a number of visualizations associated with the number of software artifacts based on the code execution flows for the program. The number of visualizations are interactive visualizations displayed in a graphical user interface for a user. The processor set identifies a number of bugs associated with the number of software artifacts for the program based on the number of visualizations associated with the number of software artifacts.

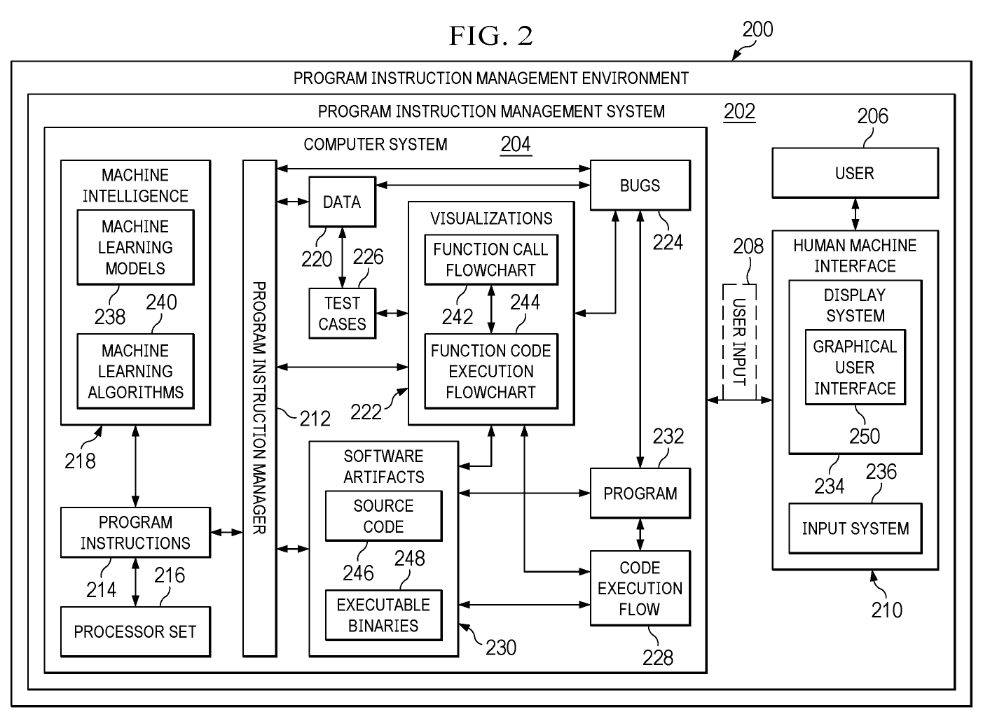

With reference now to FIG. 2, an illustration of a block diagram of a program instruction management environment is depicted in accordance with an illustrative embodiment. In this illustrative example, program instruction management environment 200 includes components that can be implemented in hardware such as the hardware shown in computing environment 100 in FIG. 1.

In this illustrative example, program instruction management system 202 in program instruction management environment 200 can be used for identifying bugs 224 for program 232. In this illustrative example, program 232 is a structured set of instructions that computer system 204 follows to perform specific tasks or operations. Program 232 can be used to serve as a detailed guide that tells a system how to process information, interact with users, or manage resources. In addition, bugs 224 for program 232 are error, flaws, or unintended behavior that causes computer system 204 to produce incorrect results, operate inefficiently, or fail unexpectedly. Bugs 224 can arise from various sources, for example, bugs 224 can arise from mistakes in coding, incorrect logic, mismanagement of resources, or unexpected interactions between different parts of computer system 204.

In this illustrative example, program instruction management system 202 includes computer system 204 which includes program instruction manager 212. Program instruction manager 212 is located in computer system 204. Program instruction manager 212 may be implemented using program instruction manager 190 in FIG. 1.

Program instruction manager 212 can be implemented in software, hardware, firmware, or a combination thereof. When software is used, the operations performed by program instruction manager 212 can be implemented in program instructions configured to run on hardware, such as a processor unit. When firmware is used, the operations performed by program instruction manager 212 can be implemented in program instructions and data and stored in persistent memory to run on a processor unit. When hardware is employed, the hardware can include circuits that operate to perform the operations in program instruction manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

As depicted, computer system 204 includes machine intelligence 218. Machine intelligence 218 can include a number of machine learning models 238 and machine learning algorithms 240. The number of machine learning models 238 is a branch of artificial intelligence (AI) that enables computers to detect patterns and improve performance without direct programming commands. Rather than relying on direct input commands to complete a task, the number of machine learning models 238 relies on input data. The data is fed into the machine, one of machine learning algorithms 240 is selected, parameters for the data are configured, and the machine is instructed to find patterns in the input data through optimization algorithms. The data model formed from analyzing the data is then used to predict future values.

Machine intelligence 218 is continuously refined over time through trial and error. Equivalence of assets or products can be effectively performed by supervised machine learning, unsupervised machine learning, or semi-supervised machine learning so that products or assets that do not match descriptively can nevertheless be matched. Over time, the data model from machine learning can provide a greater degree of flexibility in matching machine intelligence 218. It should be understood that in a production environment, attempts that may lead to failure are generally not allowed. In this illustrative example, refinement for machine intelligence 218 can be achieved by rewarding or penalizing the number of machine learning models 238 based on the difference between predicted and actual values. Ultimately, this process helps the number of machine learning models to improve their predictive ability to meet the required confidence.

Machine intelligence 218 can be implemented using one or more systems such as an artificial intelligence system, a neural network, a generative neural network, a Bayesian network, an expert system, a fuzzy logic system, a genetic algorithm, or other suitable types of systems.

The number of machine learning models 238 involves using machine learning algorithms 240 to build computation models based on samples of data. The samples of data used for training are referred to as training data or training datasets. Machine intelligence 218 can make predictions without being explicitly programmed to make these predictions. Machine intelligence 218 can be used for training and retraining computation models for a number of different types of applications. These applications include, for example, medicine, financial services, healthcare, speech recognition, computer vision, or other types of applications.

In this illustrative example, machine learning algorithms 240 can include supervised machine learning algorithms and unsupervised machine learning algorithms. Supervised machine learning can train machine learning models using data containing both the inputs and desired outputs. Examples of machine learning algorithms include Gradient Boosting algorithm, XGBoost, K-means clustering, and Random Forest algorithm.

In this illustrative example, the number of machine learning models 238 can be retrained or updated using new data or outputs generated by the number of machine learning models 238 such that parameters in machine learning algorithms 240 selected for the number of machine learning models 238 can be adjusted to improve accuracy and efficiency of the number of machine learning models 238.

In this illustrative example, program instruction manager 212 receives a number of software artifacts 230 for program 232. Software artifacts 230 include any byproducts produced during the software development. Software artifacts 230 serve as essential components that document, support, and contribute to the development, testing, and maintenance of program 232. For example, software artifacts 230 can include source codes such as source code 246, which contains program instructions written by developers such as user 206. In addition, software artifacts 230 can also include executable binaries such as executable binaries 248, which are executable versions of code that computer system 204 can run. In this example, it should be understood that software artifacts 230 include at least one of source code 246 or executable binaries 248.

In this illustrative example, program instruction manager 212 analyze software artifacts 230 to identify code execution flow 228 for program 232. Code execution flow 228 is a sequence in which program instructions within program 232 are processed and carried out by computer system 204. Code execution flow 228 defines how a program starts, progresses through different operations, making decisions, and completes its tasks.

In this illustrative example, program instruction manager 212 can generate visualizations 222 associated with software artifacts 230 based on code execution flow 228 for program 232. In this example, visualizations 222 can be interactive visualizations displayed in graphical user interface 250.

In this example, program instruction manager 212 can generate function call flowchart 242 based on code execution flow 228. Function call flowchart 242 is a visual representation of how functions interact and execute within program 232. Function call flowchart 242 illustrates the sequence in which functions are called, how data flows between functions, and how execution moves through different parts of program 232. In this example, each node in function call flowchart 242 represents an execution logic of a function call in software artifacts 230 for program 232.

In addition, program instruction manager 212 can generate function code execution flowchart 244 for each node in function call flowchart 242. In this example, function code execution flowchart 244 is a diagram that visually represents the step-by-step execution flow within a function represented by a node in function call flowchart 242. Function code execution flowchart 244 shows how instructions inside a function are processed. In other words, function code execution flowchart 244 for each node defines an execution logic for a function call that corresponds to each node in function call flowchart 242.

In this illustrative example, program instruction manager 212 can generate test cases 226 by testing different conditions and values of variables for executing function calls represented by nodes in function call flowchart 242. In this illustrative example, data 220 that is associated with variable outputs from test cases 226 can be recorded for further analysis. In this example, data 220 can include information associated with local variables, global variables, and environment variables for executing function calls represented by nodes in function call flowchart 242.

In addition, program instruction manager 212 can further annotate function call flowchart 242 and function code execution flowchart 244 using data 220. In this example, annotated versions of function call flowchart 242 and function code execution flowchart 244 can provide comprehensive information related to the operations that are carried out in program 232.

In an illustrative example, program instruction manager 212 can train the number of machine learning models 238 for detecting bugs 224 associated with software artifacts 230 using a training dataset. In this example, a training dataset can include source code 246 for program 232, executable binaries 248 for program 232, data 220 associated with variables output from test cases 226, and bugs associated with software artifacts 230 that obtained from previous analysis.

In this illustrative example, user 206 can interact with computer system 204 through user inputs to computer system 204. In this illustrative example, user input 208 can be generated by user 206 using human machine interface (HMI) 210. As depicted, human machine interface 210 includes display system 234 and input system 236. Display system 234 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, or some other suitable device that can output information for the visual presentation of information.

In this example, user 206 is a person that can interact with graphical user interface 250 through user input 208 generated by input system 236. Input system 236 is a physical hardware system and can be selected from at least one of a mouse, a keyboard, a touch pad, a trackball, a touchscreen, a stylus, a motion sensing input device, a gesture detection device, a data glove, a cyber glove, a haptic feedback device, or some other suitable type of input device. For example, user 206 can view program 232, software artifacts 230, code execution flow 228, visualizations 222, annotated versions of visualizations 222, test cases 226, and bugs 224 through graphical user interface 250. In this example, annotated versions of visualizations 222 can be displayed by overlaying data 220 on top of function call flowchart 242 and function code execution flowchart 244.

In this illustrative example, program instruction manager 212 can identify bugs 224 using visualizations 222. In this example, bugs 224 can be identified in a number of ways. For example, developers such as user 206 can interactively view function call flowchart 242 and function code execution flowchart 244 along with data 220 and test cases 226 to determine if any flaws or errors can be identified for program 232. In an alternative illustrative example, program instruction manager 212 can identify bugs 224 using the number of machine learning models 238 in an automated manner based on data 220.

In one illustrative example, one or more solutions are present that overcome a problem with detecting bugs early in software development process. Specifically, such detection can be achieved by using aids based on visualization of code execution associated with a program. As a result, one or more technical solutions may provide an ability to increase efficiency and performance in computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which program instruction manager 212 in computer system 204 enables detection of bugs for programs. In particular, program instruction manager 212 transforms computer system 204 into a special purpose computer system as compared to currently available general computer systems that do not have program instruction manager 212.

In the illustrative example, the use of program instruction manager 212 in computer system 204 integrates processes into a practical application for bug detections. In other words, program instruction manager 212 in computer system 204 is directed to a practical application of processes integrated into program instruction manager 212 in computer system 204 that supports bug detections for programs.

For example, identification of bugs ensures that program functions correctly and efficiently. Early bug detection helps prevent system crashes, performance degradation, and data corruption. It also enhances security of computer systems by eliminating vulnerabilities that could be exploited by malicious attacks. Efficient debugging reduces development time and cost, as fixing bugs later in the process often requires extensive rework.

In addition, bug detection is crucial for ensuring stable and accurate operation. Hardware bugs such as flaws in chip design or incorrect signal processing can lead to device malfunctions, overheating, and system failures. In this illustrative example, identifying and addressing these issues early helps prevent costly redesigns and manufacturing defects. In safety-critical applications such as medical devices, automotive systems, and aerospace technology, detecting hardware bugs ensures reliability and prevents catastrophic failures. In this illustrative example, proper debugging also enhances power efficiency, reduces overheating, and extends the lifespan of hardware components.

The illustration of program instruction management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, bugs 224 can also be included in a training dataset for training the number of machine learning models 238 for detecting bugs 224.

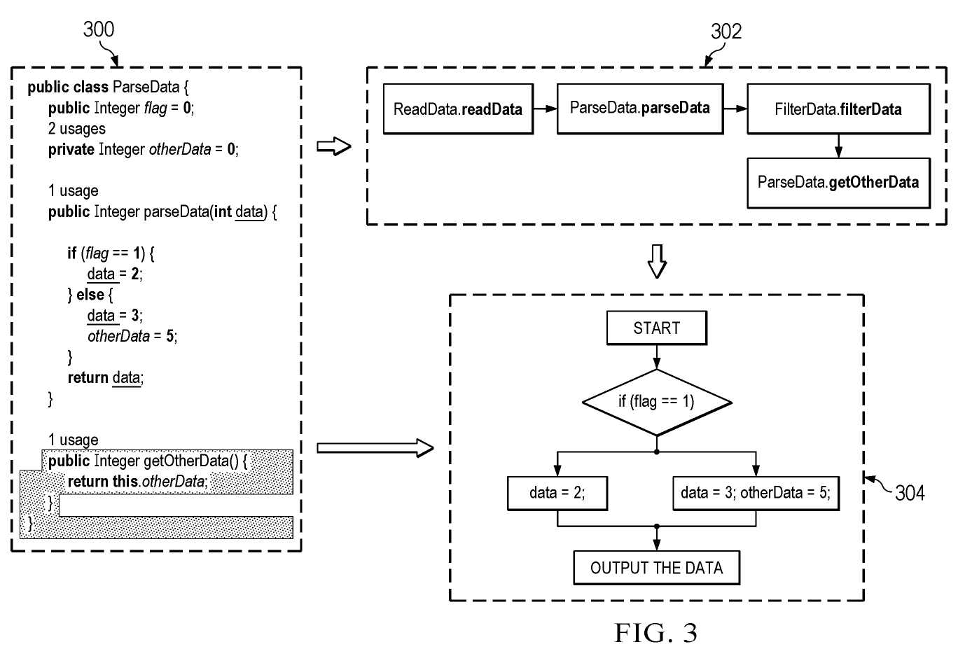

With reference now to FIG. 3, an illustration of visualizations generated for a program is shown in accordance with an illustrative embodiment. In this illustrative example, program instruction 300 can be an example of software artifacts 230 in FIG. 2, function call flowchart 302 can be an example of function call flowchart 242 in FIG. 2, and function code execution flowchart 304 can be an example of function code execution flowchart 244 in FIG. 2.

In FIG. 3, program instruction 300 includes a number of function calls for operation. As depicted, function calls are processes in which a defined function or subroutine within a system is executed when needed. Functions are reusable blocks of logic that perform specific tasks. In this illustrative example, calling a function triggers its execution.

In this illustrative example, program instruction 300 can be used for generating function call flowchart 302 that defines the dependency and relationship for function calls in program instruction 300. It should be noted that software development kit or third-party packages are omitted in program instruction 300. In this example, third-party interface calls are treated as terminal node when generating visualizations for a program containing software development kit or third-party packages. For example, the nodes for function call “ReadData.readData” and “FilterData.filterData” in function call flowchart 302 are not further analyzed.

Subsequently, function code execution flowchart 304 is generated using logic within function call “ParseData.parseData” within program instruction 300. In this illustrative example, function code execution flowchart 304 defines the execution logic for function call “ParseData.parseData” and can be used for testing purposes to identify bugs in program instruction 300.

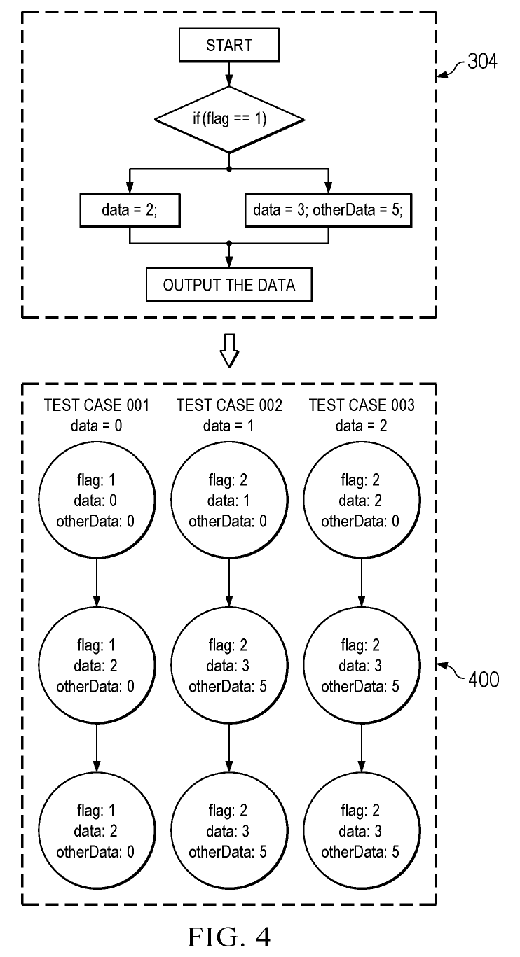

With reference now to FIG. 4, an illustration of visualizations generated for a program is shown in accordance with an illustrative embodiment. In the illustrative examples, the same reference numeral may be used in more than one figure. This reuse of a reference numeral in different figures represents the same element in the different figures. In this illustrative example, test cases 400 can be examples of test cases 226 in FIG. 2.

In FIG. 4, function code execution flowchart 304 can be used for generating test cases 400. In this illustrative example, test cases 400 represent scenarios of code executions that can be used for evaluating whether a piece of code such as program instruction 300 behaves as expected under specific conditions. In this example, test cases 400 can be essential for verifying functionality, detecting errors, and ensuring that software meets its intended requirements. In test cases 400, code executions are represented by flowcharts that present input conditions, execution steps, and expected outcomes that can be used for determining if code produces correct and consistent results.

For example, test case 1 in test cases 400 shows a flowchart that represents code execution of function call “ParseData.parseData” represented by function code execution flowchart 304 with “flag=1” and “data=0”, test case 2 in test cases 400 shows a flowchart that represents code execution of function call “ParseData.parseData” represented by function code execution flowchart 304 with “flag=2” and “data=1”, and test case 3 in test cases 400 shows a flowchart that represents code execution of function call “ParseData.parseData” represented by function code execution flowchart 304 with “flag=2” and “data=2”. In this illustrative example, local variables, global variables, and environment variables of nodes shown in test cases 400 are recorded for further analysis.

In this illustrative example, test cases 400 can be further used for developers to identify bugs in early development process, thereby reducing the risk of failures in production, and improving software reliability. In an alternative illustrative example, test cases 400 can be further used for identifying bugs in an automated manner by using machine learning models such as machine learning models 238 to determine flaws and errors within program instructions.

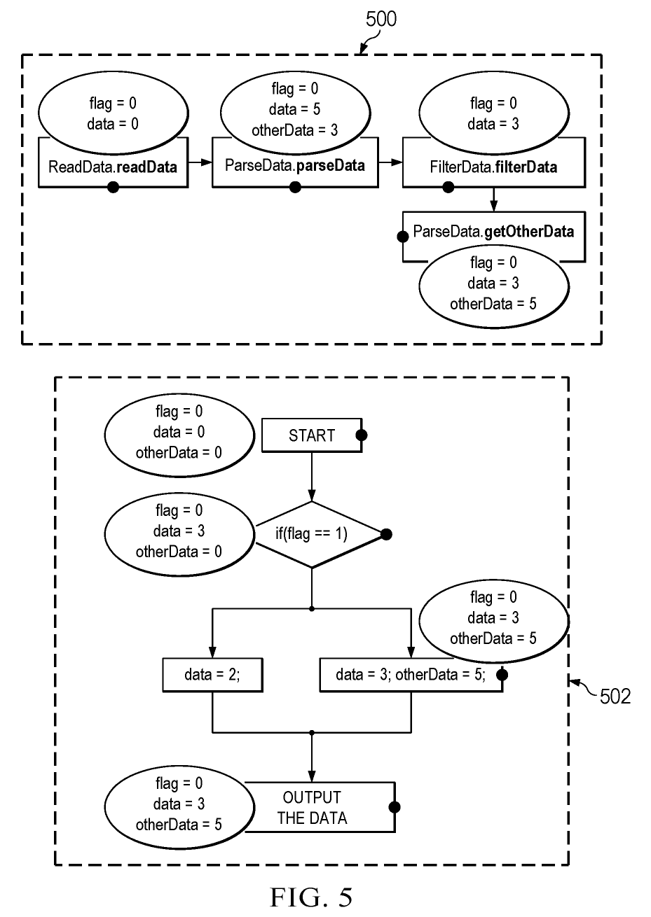

With reference now to FIG. 5, an illustration of annotated visualizations generated for a program is shown in accordance with an illustrative embodiment. In this illustrative example, annotated visualization 500 and annotated visualization 502 can be generated by overlaying information associated with variables obtained from test cases for program instruction 300 in FIG. 3.

In FIG. 5, annotated visualization 500 shows annotations to function call flowchart 302 in FIG. 3 and annotated visualization 502 shows annotations to function code execution flowchart 304 in FIG. 3. In this example, annotated visualization 500 shows information associated with variables for each function call based on a test case that involves an input argument of “data=0” and environment variable of “flag=0”.

In a similar fashion, annotated visualization 502 shows information associated with variables for each step of code execution represented by function code execution flowchart 304 based on a test case that involves an input argument of “data=0” and environment variable of “flag=0”.

In this illustrative example, annotated visualization 500 and annotated visualization 502 provide visual reports for developers during software development such that bugs in the software can be identified in an efficient manner without maneuvering different visualizations.

The illustration of annotated visualization 500 and annotated visualization 502 in FIG. 5 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, annotated visualization 500 and annotated visualization 502 can also be generated based on test cases 400 shown in FIG. 4.

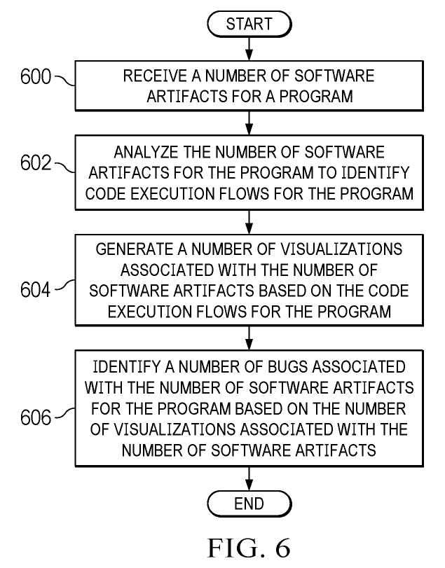

With reference now to FIG. 6, a flowchart illustrating a process for identifying bugs is depicted in accordance with an illustrative embodiment. The process in FIG. 6 can be implemented in hardware, software, or both. When implemented in software, the process can take the form of program instructions that are run by one of more processor units located in one or more hardware devices in one or more computer systems. For example, the process can be implemented in program instruction manager 212 in computer system 204 in FIG. 2.

The process begins by receiving a number of software artifacts for a program (step 600). In step 600, the number of software artifacts comprise at least one of source code or executable binaries for running the program. The process analyzes the number of software artifacts for the program to identify code execution flows for the program (step 602). The process generates a number of visualizations associated with the number of software artifacts based on the code execution flows for the program (step 604). The number of visualizations are interactive visualizations displayed in a graphical user interface for a user. The process identifies a number of bugs associated with the number of software artifacts for the program based on the number of visualizations associated with the number of software artifacts (step 606). The process terminates thereafter.

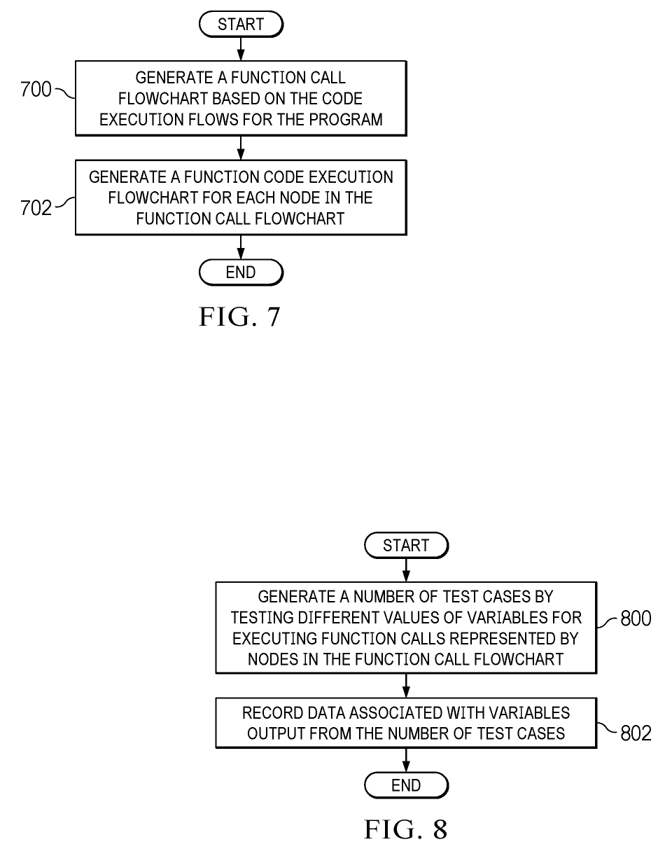

With reference now to FIG. 7, a flowchart illustrating a process for generating visualizations for the program is shown in accordance with an illustrative embodiment. The process in this flowchart is an example of an implementation for step 604 in FIG. 6.

The process begins by generating a function call flowchart based on the code execution flows for the program (step 700). In this step, each node in the function call flowchart represents an execution logic of a function call in the number of software artifacts. The process generates a function code execution flowchart for each node in the function call flowchart (step 702). In step 702, the function code execution flowchart for each node defines an execution logic for a function call that corresponds to each node in the function call flowchart. The process terminates thereafter.

With reference now to FIG. 8, a flowchart illustrating a process for recording data associated with test cases for the program is shown in accordance with an illustrative embodiment. The process in this figure is an example of an additional step that can be performed with the steps in FIG. 7.

The process begins by generating a number of test cases by testing different values of variables for executing function calls represented by nodes in the function call flowchart (step 800). The process records data associated with variables output from the number of test cases (step 802). The process terminates thereafter.

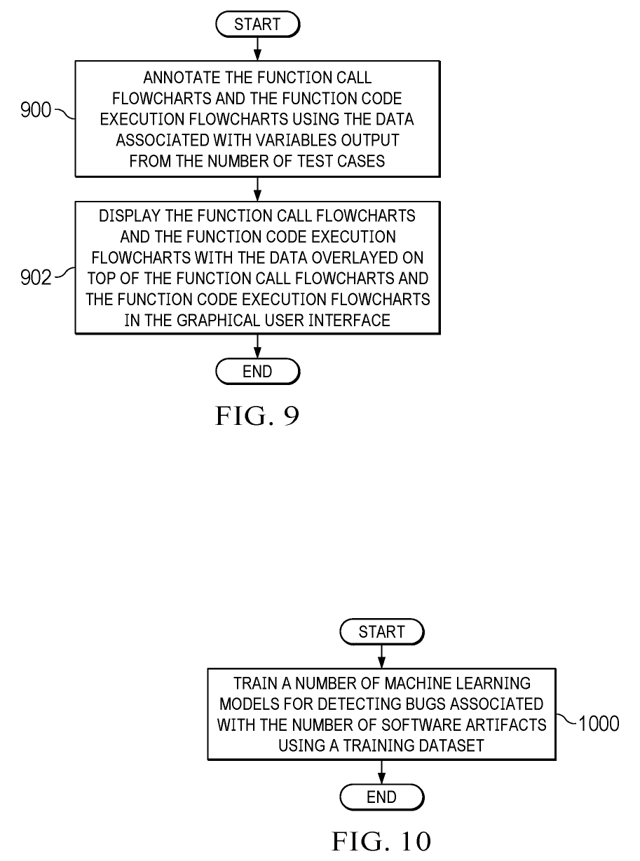

With reference now to FIG. 9, a flowchart illustrating a process for displaying visualizations for the program is shown in accordance with an illustrative embodiment. The process in this figure is an example of an additional step that can be performed with the steps in FIG. 8.

The process begins by annotating the function call flowcharts and the function code execution flowcharts using the data associated with variables output from the number of test cases (step 900). The process displays the function call flowcharts and the function code execution flowcharts with the data overlayed on top of the function call flowcharts and the function code execution flowcharts in the graphical user interface (step 902). The process terminates thereafter.

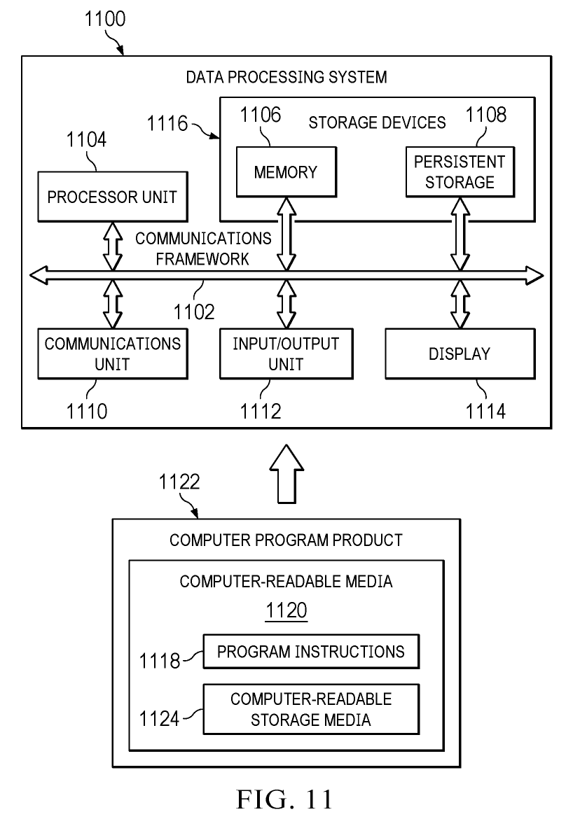

With reference now to FIG. 10, a flowchart illustrating a process for training a number of machine learning models is shown in accordance with an illustrative embodiment. The process in this figure is an example of an additional step that can be performed with the steps in FIG. 8.

The process begins by training a number of machine learning models for detecting bugs associated with the number of software artifacts using a training dataset (step 1000). In this step, the training dataset includes source code for the program, executable binaries for the program, data associated with variables output from the number of test cases, and the number of bugs associated with the number of software artifacts. The process terminates thereafter.

Turning now to FIG. 11, a block diagram of a data processing system is depicted in accordance with an illustrative embodiment. Data processing system 11 00 can be used to implement computers and computing devices in computing environment 100 in FIG. 1. Data processing system 11 00 can also be used to implement computer system 204 in FIG. 2. In this illustrative example, data processing system 1100 includes communications framework 1102, which provides communications between processor unit 1104, memory 1106, persistent storage 11 08, communications unit 11 10, input/output (I/O) unit 11 12, and display 1114. In this example, communications framework 11 02 takes the form of a bus system.

Processor unit 1104 serves to execute instructions for software that can be loaded into memory 1106. Processor unit 11 04 includes one or more processors. For example, processor unit 11 04 can be selected from at least one of a multicore processor, a central processing unit (CPU), a graphics processing unit (GPU), a physics processing unit (PPU), a digital signal processor (DSP), a network processor, or some other suitable type of processor. Further, processor unit 1104 can be implemented using one or more heterogeneous processor systems in which a main processor is present with secondary processors on a single chip. As another illustrative example, processor unit 1104 can be a symmetric multi-processor system containing multiple processors of the same type on a single chip.

Memory 1106 and persistent storage 1108 are examples of storage devices 1116. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 11 16 may also be referred to as computer-readable storage devices in these illustrative examples. Memory 11 06, in these examples, can be, for example, a random-access memory or any other suitable volatile or non-volatile storage device. Persistent storage 11 08 may take various forms, depending on the particular implementation.

For example, persistent storage 1108 may contain one or more components or devices. For example, persistent storage 11 08 can be a hard drive, a solid-state drive (SSD), a flash memory, a rewritable optical disk, a rewritable magnetic tape, or some combination of the above. The media used by persistent storage 11 08 also can be removable. For example, a removable hard drive can be used for persistent storage 1108.

Communications unit 1110, in these illustrative examples, provides for communications with other data processing systems or devices. In these illustrative examples, communications unit 1110 is a network interface card.

Input/output unit 11 12 allows for input and output of data with other devices that can be connected to data processing system 1100. For example, input/output unit 11 12 may provide a connection for user input through at least one of a keyboard, a mouse, or some other suitable input device. Further, input/output unit 11 12 may send output to a printer. Display 11 14 provides a mechanism to display information to a user.

Instructions for at least one of the operating system, applications, or programs can be located in storage devices 1116, which are in communication with processor unit 1104 through communications framework 1102. The processes of the different embodiments can be performed by processor unit 1104 using computer-implemented instructions, which may be located in a memory, such as memory 11 06.

These instructions are referred to as program instructions, computer usable program instructions, or computer-readable program instructions that can be read and executed by a processor in processor unit 1104. The program instructions in the different embodiments can be embodied on different physical or computer-readable storage media, such as memory 1106 or persistent storage 1108.

Program instructions 11 18 are located in a functional form on computer- readable media 1120 that is selectively removable and can be loaded onto or transferred to data processing system 1100 for execution by processor unit 11 04. Program instructions 11 18 and computer-readable media 1120 form computer program product 1122 in these illustrative examples. In the illustrative example, computer-readable media 1120 is computer-readable storage media 1124.

Computer-readable storage media 11 24 is a physical or tangible storage device used to store program instructions 1118 rather than a medium that propagates or transmits program instructions 1118. Computer-readable storage media 1124, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 1118 can be transferred to data processing system 1100 using a computer-readable signal media. The computer-readable signal media are signals and can be, for example, a propagated data signal containing program instructions 1118. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 1120” can be singular or plural. For example, program instructions 11 18 can be located in computer-readable media 1120 in the form of a single storage device or system. In another example, program instructions 11 18 can be located in computer-readable media 1120 that is distributed in multiple data processing systems. In other words, some instructions in program instructions 1118 can be located in one data processing system while other instructions in program instructions 1118 can be located in another data processing system. For example, a portion of program instructions 11 18 can be located in computer-readable media 1120 in a server computer while another portion of program instructions 1118 can be located in computer-readable media 1120 located in a set of client computers.

The different components illustrated for data processing system 1100 are not meant to provide architectural limitations to the manner in which different embodiments can be implemented. In some illustrative examples, one or more of the components may be incorporated in or otherwise form a portion of another component. For example, memory 11 06, or portions thereof, may be incorporated in processor unit 11 04 in some illustrative examples. The different illustrative embodiments can be implemented in a data processing system including components in addition to or in place of those illustrated for data processing system 1100. Other components shown in FIG. 11 can be varied from the illustrative examples shown. The different embodiments can be implemented using any hardware device or system capable of running program instructions 1118.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

What is claimed is:

1. A computer implemented method comprising:
receiving, by a processor set, a number of software artifacts for a program, wherein the number of software artifacts comprise at least one of source code or executable binaries for running the program;
analyzing, by the processor set, the number of software artifacts for the program to identify code execution flows for the program;
generating, by the processor set, a number of visualizations associated with the number of software artifacts based on the code execution flows for the program, wherein the number of visualizations are interactive visualizations displayed in a graphical user interface for a user; and
identifying, by the processor set, a number of bugs associated with the number of software artifacts for the program based on the number of visualizations associated with the number of software artifacts.

2. The computer implemented method of claim 1, wherein the generating, by the processor set, a number of visualizations associated with the number of software artifacts based on the code execution flows for the program comprises:
generating, by the processor set, a function call flowchart based on the code execution flows for the program, wherein each node in the function call flowchart represents an execution logic of a function call in the number of software artifacts; and
generating, by the processor set, a function code execution flowchart for each node in the function call flowchart, wherein the function code execution flowchart for each node defines an execution logic for a function call that corresponds to each node in the function call flowchart.

3. The computer implemented method of claim 2, further comprising:
generating, by the processor set, a number of test cases by testing different values of variables for executing function calls represented by nodes in the function call flowchart; and
recording, by the processor set, data associated with variables output from the number of test cases.

4. The computer implemented method of claim 3, wherein the number of bugs associated with the number of software artifacts for the program are identified based on the data associated with variables output from the number of test cases.

5. The computer implemented method of claim 3, wherein the data comprises information associated with local variables, global variables, and environment variables for executing function calls represented by nodes in the function call flowchart.

6. The computer implemented method of claim 3, further comprising:
annotating, by the processor set, the function call flowcharts and the function code execution flowcharts using the data associated with variables output from the number of test cases; and
displaying, by the processor set, the function call flowcharts and the function code execution flowcharts with the data overlayed on top of the function call flowcharts and the function code execution flowcharts in the graphical user interface.

7. The computer implemented method of claim 3, further comprising:
training, by the processor set, a number of machine learning models for detecting bugs associated with the number of software artifacts using a training dataset, wherein the training dataset comprises source code for the program, executable binaries for the program, data associated with variables output from the number of test cases, and the number of bugs associated with the number of software artifacts.

8. A computer system comprising:
a processor set;
a set of one or more computer-readable storage media; and
program instructions stored on the set of one or more storage media to cause the processor set to perform operations comprising:
receiving a number of software artifacts for a program, wherein the number of software artifacts comprise at least one of source code or executable binaries for running the program;
analyzing the number of software artifacts for the program to identify code execution flows for the program;
generating a number of visualizations associated with the number of software artifacts based on the code execution flows for the program, wherein the number of visualizations are interactive visualizations displayed in a graphical user interface for a user; and
identifying a number of bugs associated with the number of software artifacts for the program based on the number of visualizations associated with the number of software artifacts.

9. The computer system of claim 8, wherein the generating a number of visualizations associated with the number of software artifacts based on the code execution flows for the program comprises:
generating a function call flowchart based on the code execution flows for the program, wherein each node in the function call flowchart represents an execution logic of a function call in the number of software artifacts; and
generating a function code execution flowchart for each node in the function call flowchart, wherein the function code execution flowchart for each node defines an execution logic for a function call that corresponds to each node in the function call flowchart.

10. The computer system of claim 9, wherein the operations further comprise:
generating a number of test cases by testing different values of variables for executing function calls represented by nodes in the function call flowchart; and
recording data associated with variables output from the number of test cases.

11. The computer system of claim 10, wherein the number of bugs associated with the number of software artifacts for the program are identified based on the data associated with variables output from the number of test cases.

12. The computer system of claim 10, wherein the data comprises information associated with local variables, global variables, and environment variables for executing function calls represented by nodes in the function call flowchart.

13. The computer system of claim 10, wherein the operations further comprise:
annotating the function call flowcharts and the function code execution flowcharts using the data associated with variables output from the number of test cases; and
displaying the function call flowcharts and the function code execution flowcharts with the data overlayed on top of the function call flowcharts and the function code execution flowcharts in the graphical user interface.

14. The computer system of claim 10, wherein the operations further comprise:
training a number of machine learning models for detecting bugs associated with the number of software artifacts using a training dataset, wherein the training dataset comprises source code for the program, executable binaries for the program, data associated with variables output from the number of test cases, and the number of bugs associated with the number of software artifacts.

15. A computer program product comprising:
a set of one or more computer-readable storage media;
program instructions stored in the set of one or more computer-readable storage media to perform operations comprising:
receiving, by a processor set, a number of software artifacts for a program, wherein the number of software artifacts comprise at least one of source code or executable binaries for running the program;
analyzing, by the processor set, the number of software artifacts for the program to identify code execution flows for the program;
generating, by the processor set, a number of visualizations associated with the number of software artifacts based on the code execution flows for the program, wherein the number of visualizations are interactive visualizations displayed in a graphical user interface for a user; and
identifying, by the processor set, a number of bugs associated with the number of software artifacts for the program based on the number of visualizations associated with the number of software artifacts.

16. The computer program product of claim 15, wherein the generating, by the processor set, a number of visualizations associated with the number of software artifacts based on the code execution flows for the program comprises:
generating, by the processor set, a function call flowchart based on the code execution flows for the program, wherein each node in the function call flowchart represents an execution logic of a function call in the number of software artifacts; and
generating, by the processor set, a function code execution flowchart for each node in the function call flowchart, wherein the function code execution flowchart for each node defines an execution logic for a function call that corresponds to each node in the function call flowchart.

17. The computer program product of claim 16, wherein the operations further comprise:
generating, by the processor set, a number of test cases by testing different values of variables for executing function calls represented by nodes in the function call flowchart; and
recording, by the processor set, data associated with variables output from the number of test cases.

18. The computer program product of claim 17, wherein the number of bugs associated with the number of software artifacts for the program are identified based on the data associated with variables output from the number of test cases.

19. The computer program product of claim 17, wherein the data comprises information associated with local variables, global variables, and environment variables for executing function calls represented by nodes in the function call flowchart.

20. The computer program product of claim 17, wherein the operations further comprise:
annotating, by the processor set, the function call flowcharts and the function code execution flowcharts using the data associated with variables output from the number of test cases; and
displaying, by the processor set, the function call flowcharts and the function code execution flowcharts with the data overlayed on top of the function call flowcharts and the function code execution flowcharts in the graphical user interface.
